(19) United States
(12) Patent Application Publication
(10) Pub. No.: US 2017/0321826 A1
(43) Pub. Date: Nov. 9, 2017

(54) SINGLE LEAD WEDGETHREAD CONNECTION

(71) Applicant: Patented Products LLC, Pearland, TX (US)

(72) Inventor: John Dawson Watts, Washington, TX (US)

(73) Assignee: Patented Products LLC, Pearland, TX (US)

(21) Appl. No.: 14/822,899

(22) Filed: Aug. 11, 2015

Related U.S. Application Data
(60) Provisional application No. 62/036,618, filed on Aug. 12, 2014.

(51) Int. Cl. F16L 15/00; F16L 15/06; E21B 17/042; F16L 25/10; F16L 25/08

(52) U.S. Cl. CPC F16L 15/001; F16L 25/10; F16L 25/08; E21B 17/042; F16L 15/004; F16L 15/06

(57) ABSTRACT

An affordable family of threaded pipe connections is disclosed, that have desired strengths and service torques, for a wide range of sizes and services.

Features of this Invention can be used with many types of screw threads but are described herein for use on OCTG Tapered Pipe Threads that are subject to many extreme service demands that best illustrate use of the invention's feature's, however, features of this invention may also be used on other tapered or cylindrical screw threads, even Bolts and nuts. Included by reference are U.S. Pat. Nos. 5,427,418; 6,578,880; 8,818,998 & U.S. patent application Ser. No. 13/434,443. The Present Application claims Priority on U.S. Provisional Patent Application No. 62/036,618, filed Aug. 12, 2014.

### FIELD OF THE INVENTION

The 8V sharp-crest thread form used on nuts & bolts was modified for use as the first tapered API pipe thread but they often galled upon assembly, so to reduce galling, API adopted the 8Rd thread form in 1939, which is the most common OCTG thread in use today.

API 8Rd thread 5B Specifications required 2 to 3 power makeup turns (turns under Box/Pin radial thread interference to tighten) but that was increased by API in 2007 to as much as 5 turns to lessen pullout failures and/or leakage, but unfortunately more power turns generate even more heat that causes galling between the box and pin threads which In turn, causes more leakage, galling and/or make-up short of the intended tight position and it also reduces mechanical strength.

To reduce but not eliminate galling, API 5A2 Thread Compound (dope) having a very low 0.021 coefficient of friction (COF) is used typically, but it causes too low a service torque required for many current services such as the current surge in shale drilling and Geothermal Wells. However, such solids mixed in the dope, increase environmental damage.

API 8Rd threads are formed with 60 degree included angles between flanks which limits torque and pull-out strength particularly on large pipe, so it is easily over-tightened and/or it loosens in service, causing leakage and/or pullout which greatly increases costs and RISKS. API 8Rd threads use the same 30 degree flank angle for pipe thread sizes ¼″ to 48″ that have vastly different t/D ratios (pipe wall thickness/pipe OD), that ratio being directionally proportionally to pipe yield pressure for each material grade which alone, reduces reliable service ratings. Even still today, some current API coupling OD's specified are overstressed at their specified service loads, so those coupling OD's should be increased or the coupling should be de-rated.

To have thread lengths long enough to attain usable service ratings with the inefficient 60 degree included angle 8Rd thread form, API threaded connections have a 0.0625“/” taper that causes it to require those several makeup turns that generates the heat and galling between mating threads. Torque ratings are increased on some sizes by upsetting pipe ends before threading to increase interface thread pressures and torque, but excessive costs and undesirable thread diameter increases are caused, and both increase the friction heat that often causes galling and increase of pipe sizes it is run within, making upset pipe too expensive in many wells. For sixty years “Dual Lead Dovetail Wedgethreads” have provided higher torque ratings but with poor sealing and false makeup problems, and they increase machine time and assembly time, plus difficulty of gauging and a very high susceptibility to damage, and they can be machined only on expensive CNC machines. My U.S. Pat. No. '880 introduced an “Open Wedgethread” that solved those problems. Buttress type threads, having radial contact between crests & roots are used, but their sealing ability and service torque are not sufficient for many jobs such as shale drilling. Various schemes to butt the pin ends have been devised to increase torque of API Buttress threads but they are very limited in capacity and are subject to accidental loosening down-hole, when uneven pipe twist occurs. Hundreds of proprietary pipe thread forms have been used during the last hundred years, but none to my knowledge and belief, provide advantages of the present invention for a family of threaded connections. A review of widely used thread forms shows ratios of (flank bearing strength/shear strength at pitch line) as follows, figuring unit shear strength of steel at ⅔ its ultimate strength: Sharp V=0.8/(0.50*0.66)=2.4; 8Rd=0.75/(0.5*0.66)=2.27; Acme=0.5/(0.5*0.666)=1.5; Stub Acme=0.3/(0.5*0.66)=0.90; API 5 Buttress Stab Flank=(0.062−0.03−0.008)/(0.10*0.66)=0.36; API 5 Buttress Load Flank=(0.062−0.008−0.01)/(0.1*0.66)=0.66. If the ratio of the (bearing strength/ shear strength) of any special thread forms are accidentally within the ratio taught by the present invention but were not explained to be an efficient thread form and used by others, then the area ratio range taught by the present Invention Is still novel.

The thread form of the present invent may have a thread depth equal to 40% of the axial pitch and a flank bearing width equal 33% of the axial pitch expressed by the following formula which also considers the bolt thread root diameter and its axial strength. Where: L=engaged thread length required for a balanced nut/bolt threads; PD=thread pitch diameter; TPI=threads per inch; RD=thread root diameter then L=PD/(RD)̂2. Then if a 1″ 8TPI bolt & nut is chosen, in accord with the present invention: PD=1−0.125/3=0.958″ & Root Dia=1−0.25/3=0.917″; so L=1/0.917=1.09″. However, the root diameter of a UNC 1″ 8V bolt=0.8466″ allows a bolt strength relative to this invention=(0.8466/0.917)̂2=85%. It is true that the UNC thread has more flank bearing area, but it is of no use because of the tension strength. The present invention provides a flank bearing strength substantially equal to the shear strength for any TPI selected.

### SUMMARY OF THE PRESENT INVENTION

I call the Present Invention a “Single-Lead Wedgethread” because it firmly wedges pin thread flanks between mating box thread flanks having proper flank angles, within a fraction of a turn as do wedgethreads, to provide advantages of a double-lead Wedgethread without incurring double-lead machining and gauging costs or field difficulties, and further, it may be used on full-strength pins formed on non-upset pipe, greatly reducing fatigue stresses as taught in my U.S. Pat. Nos. '880 and '996. I believe that it will become an Industry Standard Connection because It has so many advantages over existing standard connections. The present invention uses a shallow thread depth combined with a fast taper, to reduce the number of power makeup turns whereas a wedgethread uses a double lead.

As the ratio of a pipe wall's thickness to its diameter (t/D) is reduced, its resistance to internal and external fluid pressure is also reduced, so this invention teaches selection of flank angles as necessary to exert hoop stresses less than the material yield strength but sufficient to seal and attain desired torque and pull-out strength without overstressing the pipe walls. A family of tapered thread pipe connections assembled to attain a suitable radial pressure between pin and box threads as required to seal against fluid pressure and also have rated axial, tension, bending, and torsion strengths, has tension hoop stress in the box and compressive hoop stress in the pin and must also withstand rated mechanical and fluid service loads without exceeding the yield stress of the box or pin materials. Additionally, it must not allow relative movement between box and pin threads while in service, to maintain leak tightness and prevent thread jump-out. Flank angles too large for a given pipe t/D will allow the pin to leak and/or jump-out of the box, whereas if flank angles were too small, the flanks will yield and gall before makeup position is attained. This invention teaches use of like flank angles within each pipe size group, but different flank angles between the size groups in other families of pipe connections necessary to cover all pipe sizes desired. However other flank angle groupings such as a thick and thin group within a given pipe size group with the thick group having a larger flank angle than the thin group, are within the teachings of the present invention. Box and pin hoop stresses from radial forces transmitted through flank angles, generate radial loads between mating pin and box threads to seal and effect a desired thread makeup torque, which must be low enough to be practically tightened (with a large enough flank angle) but high enough to seal and prevent loosening in service (using a flank angle not too large). The smaller the flank angle, the higher the flank pressure and the torque for a given thread interference, so the optimum flank angle varies generally in steps, with the pipe t/D. Therefore, one of the features the present invention teaches is a selection of thread flank angles for each size group that will seal without galling or jump-out, and not loosen. Whereas API 8Rd 5B threaded connections use thirty degree flank angles on all pipe sizes from ½″ to 30″, the present invention teaches use of a selected flank angle for each pipe size group, to substantially upgrade connection performance. For instance: 35 degree flank angles may be used on pipe sizes 4″ and smaller; 25 degree flank angles on 4.5″-5.5″; 20 degree flank angles on sizes 6.625-7.625; 15 degree flank angles on 8.625 and larger to both seal and provide sufficient strength and optimum torque.

The steep [0.14″ diameter per axial inch taper] and multiple thread starts of the present Invention may reduce the number of power makeup turns from five turns now required by many API Pipe Threads, to less than one turn, which prevents the heat buildup and galling that several makeup turns under thread interference cause on existing connections and therefore, it also eliminates need for a dope having a low COF and environmentally offensive metals. (There are weld-neck connections being used that can be made-up in less than one turn, but they have reduced bores and/or enlarged OD's and are therefore not suitable for regular pipe connections due to both size and cost.) High torque ratings of the present invention may be attained by using both a small included angle between wedging flanks, and a High COF Dope allowed by the fast taper, which increases flank bearing stress to predetermined values less than the material yield stress when tight, with a minimum thread length. Thus, less expensive Dopes having higher COF's, lower costs, and more efficient fillers for sealing without environmental contaminates can be used to seal and safely attain the now desired higher Service Ratings, without galling.

The Included angle of a thread form is the sum of the stab flank angle and the load flank angle, which if made too large for a given pipe size and wall thickness, causes the box to expand and the pin to contract too much to seal and/or attain the design torque, and it also causes tangential overstress of the box and pin upon makeup and/or when service loads are applied. Conversely, included angles too small may yield the flanks in bearing before the predetermined thread Interference position Is reached, and also cause excessive torque. Therefore, this Invention teaches a workable range for the included angles for any combination of pipe OD, pipe wall thickness, pipe yield strength, COF and thread taper for a family of Pipe Connections, while also retaining reasonable interchangeability within each pipe size group, such that a thin wall pin may be connected with a thicker wall box longer thread.

The threads may be dimensioned to seal the gap between crest and root as taught in my '418 Patent and use of high COF environmentally safe solid dope particles having good resistance to heat and chemical attack, such as Talc. Other seals such as nose seals may be used with both the steep taper and a suitable flank angle without departing from the spirit of this invention. A connection with a steep thread taper but with an included angle too large, results in low torque and low service ratings, whereas, if the included angle is too small, the connection may gall, leak, and lockup short of the design makeup position. A workable included angle with a 0.0625 API taper still results in excessive heat buildup, galling and leakage as described above.

Also taught by the present invention is a novel thread form having balanced strengths in axial tension, compression and shear, that allows a minimum thread length and height within the available space for mating threads, to withstand maximum service loads regardless of the thread pitch, which In turn, allows reduction of a connections size and cost. Most steels have a shear strength of approximately two-thirds of their ultimate tensile strengths, so as opposed to the practice of millions of designers just accepting existing standard thread forms during the last 100 years, the present invention teaches a thread form having the highest strength within any given space, by making the thread load flank bearing strength substantially equal to the thread shear strength, so the flank will not fail in bearing before the thread shears, nor will the thread shear before the flank fails in bearing. The bearing area on a given flank width, and thus the thread efficiency, may be maximized by using guide angles having the least practical radial width such as a 0.010″ wide taper in place of large crest radii like the 0.030″ radius used on API Buttress threads of FIG. 3, or the 0.020″ radius used on API 8Rd threads as shown in FIG. 4. A radius between the guide surface and the flank surface only large enough for tool grinding purposes such as R.005″ is permissible because the guide surface width will not allow the radius to contact a like radius on a mating thread.

Most threaded OCTG pipe connections must be assembled with use of special stab-guides, especially in rough weather within acceptable time limits without cross-threading or other damage, so the present invention also teaches features that provide major improvements in a connection's assembly characteristics. When prior art pin threads are perfectly centralized within box threads, they can still gall if rotated or lowered into a box in a rotational position that allows contact of mating threads at extreme pressure angles, thereby causing tiny pieces of a pin thread crest to weld to tiny pieces of the mating box thread crest which form small steel balls that roll and grow between mating threads until they lock up the connection and cause leakage. Therefore, the present invention also teaches forming of mating threads in FIG. 6 to have mating guide surfaces adjacent the crests at angles measured from the axis to preclude extreme pressure angles of existing threads, the guide surface being positioned at an angle measured from the axis sufficient to prevent thread contact at extreme pressure angles and thereby, prevent thread galling due to friction heat. Ideally, the guide angle should be no less than the angle of friction plus the maximum allowable misalignment angle specified for the drilling rig, nor larger than 40 degrees.

### BRIEF DESCRIPTION OF THE DRAWINGS

FIG. 1 Depicts a half section of a Connection in accord with the Invention;

FIG. 2 Depicts a preferred thread form;

FIG. 3 Depicts the pin as it is being stabbed into the box during their assembly.

### DETAILED DESCRIPTION OF PREFERRED EMBODIMENTS

The Screw thread form shown in FIG. (2) has an axial thread pitch (8) and a radial thread depth (29) that is at least 30% but not more than 50% of the axial thread pitch, which provides a most efficient thread form for steel threads because the thread flank axial bearing strength substantially equals the thread axial shear strength at the pitch diameter. When threads are made of other materials, the ratio of the thread depth/pitch may be different for the shear strength to equal the flank bearing strength. The thread form may also have a load flank (34) and a load flank bearing width (33) the load flank bearing width being substantially ⅓ of the axial pitch. Guide surfaces (44, 46) may be formed between the flanks and crests (35) on guide angle (45) to prevent contact between mating threads at extreme pressure angles. The guide angles measured from the connection centerline (43) are greater than the angle of friction that acts between mating threads and preferably, greater than the angle of friction plus the maximum misalignment allowed between the pin and box during assembly but less than 40 degrees. The included angle (30) between flanks is large enough to limit flank bearing pressure to less than pipe yield stress but small enough to cause a torque within a desired range.

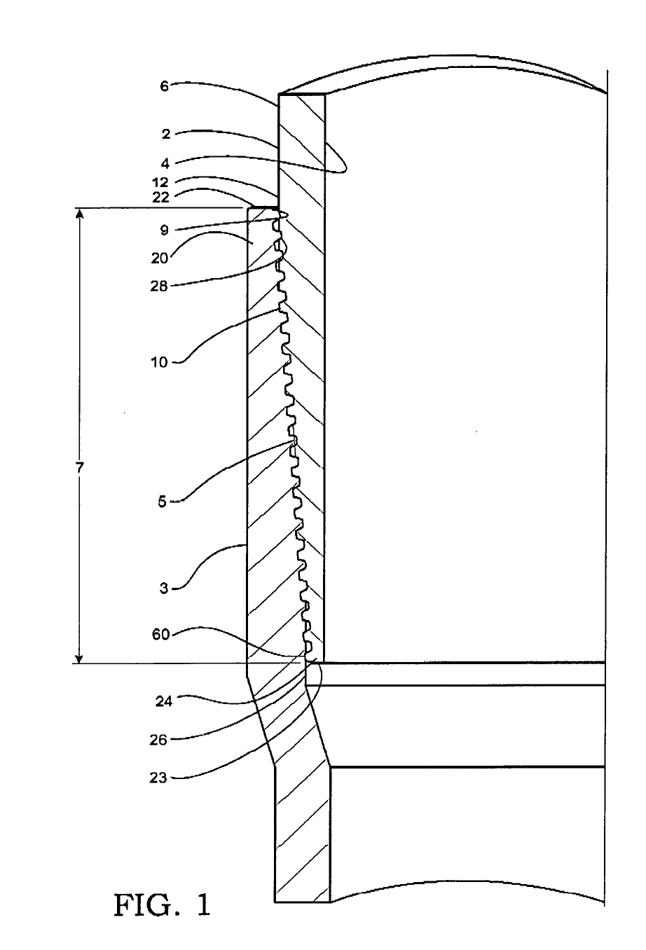

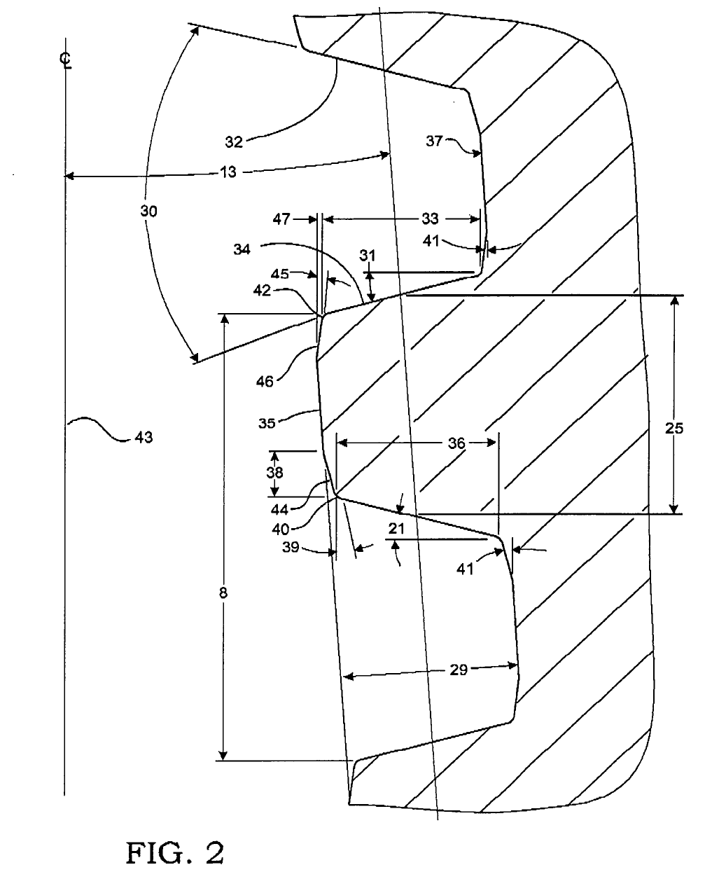

As shown in FIG. 1, non-upset Pin (2) may be formed to have: pin ID (4), pin face (23) and tapered pin threads (10) that extend from the face to thread root run-out (9) on the pin neck OD (12), to selectively provide a pin having a strength of 75% to 100% of the pipe strength. Non-upset but swaged Box (20) may be formed with box OD (3), box face (22), and mating tapered box threads (28) that extend substantially from the box face to the box ID (26) so as to selectively provide a box having a strength of 75% to 100% of the pipe strength. Both pin and box threads are formed with stab flank angle (21) and load flank angle (31) shown In FIG. 2, the angles being selected to provide a desired makeup torque within a given range, a predetermined pullout-resistance, selected flank bearing stresses and predetermined hoop stresses in the box and pin. It is preferred that all threads of a given pipe size be interchangeable, however, a thick wall group and a thin wall group within a size may best serve some services.

For a given pipe material, the torque required to assemble a flank wedging connection under standard conditions to a desired makeup position as shown in FIG. 1, is dependent upon: box OD, pin ID, thread average diameter (5), diametrical thread interference, flank angles, thread taper, flank surface finish, thread dope used as a paste or dry film, and the engaged thread length (7). The thread length required to attain a given mechanical design rating is affected by the thread form, and this invention teaches a most efficient thread form in which, the flank bearing strength substantially equals the thread shear strength, i.e. The thread form shown on FIG. 2 comprises: load Flank Bearing Width (33) positioned on flanks between crests and roots (37), the bearing width being substantially equal to one-third of the axial thread pitch for steel threads. Small guide angles (39, 45) measured between the thread guide surface (44, 46) and the connection centerline (43), are greater than the effective angle of friction between the mating threads and preferably greater than the angle of friction plus the maximum allowable assembly misalignment angle for the connection. Guide surfaces are positioned between the crest and flank to prevent galling between pin and box threads during stabbing and tightening of the pin into the box. Thus, the highest load capacity per axial inch of engaged thread is attained regardless of the thread pitch and therefore, the pitch can be selected based on other factors such as available radial space, threading costs, interchangeability, crossthreading tendency, resistance to damage and/or sealing requirements.

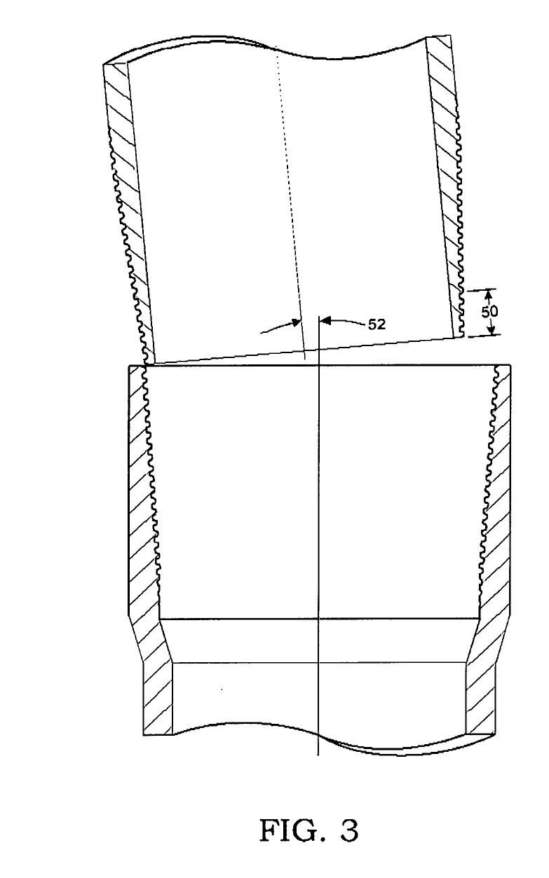

Cross-threading of mating threads while stabbing has been a problem for hundreds of years since screw threads were first invented, but the present invention now solves that problem. Based on the specified maximum misalignment angle (52) shown in FIG. 3 for a given drilling rig, this invention also teaches a pipe thread axial-lead equal or greater than, [Pipe OD*tan (misalignment angle)] so as to not cross-thread. Thus, if the acceptable (misalignment angle+friction angle) is four degrees, the minimum lead for a 14″ OD pipe thread that will not cross-thread=14*tan (4 deg)=0.979″ Lead or greater. Then if four TPI is selected, a four-start 4 TPI thread (having a one inch lead) is ideal for a 14″ pipe thread; a three start thread (with a ¾″ lead) is ideal for a 11″ pipe thread; a two-start 4 TPI (with a ½″ lead) is ideal for a 7″ OD pipe thread, and a one-start 4 TPI (with a ¼″ lead) is ideal for 3.5″ OD & smaller pipe threads to prevent cross-threading, with all 14″ and smaller sizes possibly using the same threading insert to reduce costs for a family of threads.

Another teaching of this invention is to set the minimum Number of Engaged Threads=(the pipe wall max thickness)/(the thread form bearing width)+ROT; (where ROT=number of Run-out threads at necks.) when a full-strength connection is wanted on non-upset pipe, or any portion thereof for lower strength connections. The pin OD may be swaged down to the minimum API allowable pipe OD and bored to a Pin ID=(pipe nominal ID+Pipe drift diameter)/2 which provides the minimum OD pin for a full strength full bore connection. If twice the minimum practical pin face width (23) is added to pin ID (4), then the minimum practical root diameter (24) at the pin face is quantified, and the Max practical thread taper for a given pipe thread then equals the (pin OD—face root diameter)/(Required Thread length) for a run-out thread, regardless of the pipe material strength. For a family of pipe connections, the maximum and minimum pipe wall thicknesses and the minimum practical pin face width can be used to find a suitable common thread taper for each group.

The minimum pin crest diameter (60) may be used as the coupling ID to calculate the minimum coupling OD (3) for both pressure and mechanical loads, which in fact, provides a full pipe wall thickness. Radial thread interference may be calculated=0.7*Y/E*(Pipe OD) to attain full strength under all service loads.

With the above factors known, the optimum make-up torque of an efficient connection may be determined by selection of a dope COF and the Included angle, knowing that the smaller the included angle, the higher the flank psi and the torque. As taught above, a dope having a high COF can be used if a connection's power makeup with that dope does not require enough interference turns that would generate enough heat to cause galling. Therefore, inexpensive dopes with COF's such as 0.10, (5 times the COF of API 5A2 dope) may be used, that don't contain environmentally offensive solid particles in the dope to reduce friction. A higher COF of the solid particles also improves sealing of the fluids because such solid particles resist extrusion through thread gaps by service pressures. Thread interference at the box face may set be less than at the pin face, if the hoop stress at the box face under rated pressure exceeds the allowable stress after which, the average interface psi over the engaged thread length may be found. Then multiplying the conical thread area by that average psi will determine the total radial interface force between box/pin flanks, and dividing that load by tangent of the flank angles (or tangent averages if flank angles not equal) will determine the total flank axial load that causes makeup friction. Finally, multiplying the (friction load *COF/24* the average thread pitch diameter) determines the ft-lb makeup torque. If the same formulas are rearranged and a desired torque is inserted, the minimum allowable flank angle may be found for a given connection, or averaged for a group of sizes. The threads will seal easily because solids in the dope required to seal need not have a low COF, so they can be selected from soft, low cost, high COF, temperature resistant, chemical attack resistant solids such as Talc, and their high COF will additionally, lend great resistance to their being extruded by the fluid pressure. However, auxiliary seals may be provided when necessary to satisfy specific service codes. To insure against a tension load being able to cause axial movement between box and pin threads, leakage and/or pull-out, the total radial load acting between mating threads should be divided by the pipe axial yield load to find the arc tangent of a maximum allowable load flank angle. The rounded-off average of minimum and maximum flank angles of a family group of connections within a practical size range may be adopted as the flank angle for that group. When designing a pipe connection, the required length of engaged threads to attain a desired mechanical rating will vary closely with the pipe wall thickness, so such as 6 TPI with a small thread depth may be independently selected as best suited for 4″ and smaller pipe which generally have thinner walls, and such as 4, 3, or 2 TPI may be selected for progressively larger pipe sizes.

Each size connection has a minimum and a maximum workable flank angle. The max flank angle allowable=ATN(total radial force between threads/pipe yield load) to prevent leakage and/or pull-out of the pin from the box. The flank angle must both seal and provide the torque required without yielding flanks under any combination of rated loads.

Should the hoop stress in the pin end when under rated external pressure exceed the yield stress of the material, then either the external service pressure rating must be reduced or the wall thickness of the box face must be increased. If the box face hoop stress is excessive when under internal pressure, the thread interference at the box face may be reduced by increasing the box face PD, which increases the box thread taper providing, the reduced interface thread pressure is still high enough to withstand end loads, strengths and service torques, for a wide range of sizes and services.

I claim:

1. A screw thread form having a radial thread depth (29) and an axial thread pitch (8), comprising: The thread depth being more than 30 percent but less than 50 percent of the axial thread pitch.

2. The screw thread form of claim 1, further comprising: The thread depth being substantially 40 percent of the axial thread pitch.

3. The screw thread form of claim 2 also having a load flank (34) and a load flank radial bearing width (33), comprising: The radial bearing width being substantially one-third of the axial pitch.

4. A thread form having a crest (35); a stab flank (32); a stab flank guide surface (44) positioned at guide angle (39) with respect to the connection centerline (43); further comprising: The guide angle being larger than the angle of friction that acts between the mating threads, but less than 40 degrees.

5. The thread form of claim 4 also having a load flank guide surface (46) positioned at guide angle (45) with respect to the connection centerline (43); further comprising: The guide angle being larger than the angle of friction that acts between the mating threads, but less than 40 degrees.

6. The screw thread form of claim 3 also having a root (37), an included angle (30) between the flanks, the thread flanks having a rated bearing pressure, comprising: The included angle being dimensioned large enough to limit flank bearing pressure to within the rated bearing pressure when at rated load; The included angle being dimensioned small enough to cause a flank bearing load sufficient to effect a predetermined makeup torque upon connection assembly.

7. The thread form of claim 4 also having a maximum allowable angle of misalignment (52) between the pin and box during their assembly, further comprising: The guide angle being greater than the maximum rated angle of misalignment plus the angle of friction.

8. A pipe connection pin (2) having pin threads (10), pin thread OD at face (60), pin root diameter (9), crest diameter at face (60), the connection also having box (3) formed with tapered threads (10) to mate with the pin threads, box OD (3), box swaged ID (26), comprising: The pin being swaged down to the smallest OD within pipe OD tolerance and the pin ID being formed substantially equal to the average of the pipe drift diameter and the nominal pipe ID; the pin thread root diameter substantially running out at the pin OD; The box ID being swage out to substantially the pin crest diameter at face; the box thread root running out in the swaged box ID; the engaged thread length extending from the pin OD to the box ID.

9. A family of pipe connection groups in accord with claim 3, further comprising: Each group having like flank angles but different flank angles than other groups within the family, as necessary to prevent flank yield stresses and excessive box or pin hoop stresses and to provide maximum service ratings at minimum cost.

10. The family of claim 9 wherein the threads have a stab flank angle (21), a load flank angle (31), the stab flank angle plus the load flank angle being an included angle (30), the threads being dimensioned such that when mating flanks are in contact upon makeup, the connection has a yield torque at which the flanks will yield in bearing, the flanks being coated with a thread dope having a selected COF, comprising: The included angle and dope COF being selected to attain a makeup torque of more than one-third but less than two-thirds, of the flank yield torque.

11. A family of pipe connections in accord with claim 9 having a pin (2) and a box (3) with a pin thread (10) being loaded radially against a box thread (28) upon assembly with a predetermined radial load, the connection having a rated axial load, comprising: The flank angles and diameters being dimensioned to withstand all rated loads without there being relative movement between the box and pin threads.

12. The family of pipe connections of claim 10, further comprising: The flank angles being dimensioned large enough to prevent radial flank loads from exerting a flank stress that exceeds the material yield stress.

13. A family of pipe connections in accord with claim (9) further comprising: Threads for pipe sizes 4.5″ through 5.5″ having flank angles larger than 20 but less than 30 degrees; Threads for pipe sizes 5.5″ through 7.625″ having flank angles larger than 15 degrees but less than 25; Threads for pipe sizes 8.625″ and larger having flank angles larger than 10 but less than 20 degrees.

14. A threaded pipe connection having a box (3) with tapered box threads (28) and a box face (22); the connection also having a pin (2) with tapered pin threads (10) dimensioned to mate with the box threads, radial interference existing between the mating threads, the box wall being thicker at the pin face that at the box face, comprising: More radial thread interference existing between the mating threads at the pin face than at box face; Interference at the pin face being sufficient to seal rated Internal fluid pressure but less than flank yield pressure; Interference at box face not being great enough to over stress the box wall when at rated pressures.

15. The pipe connection of claim 9 having a thread form in accord with claim 4.

16. The pipe connection of claim 9 having a thread form in accord with claim 5.

17. The pipe connection of claim 9 having a thread form in accord with claim 6.

18. The pipe connection of claim 9 being in accord with claim 7.

19. Families of threaded pipe connections, each family being within a specific wall thickness/diameter range, all threads within that family having an optimum thread form for that range.

20. A threaded connection In accord with claims (1, 3, 5, 7, 8, 9, 10, 13, 14, and 20), having a taper, further comprising: The taper being greater than 7/100 inch per axial inch.

21. A threaded connection in accord with claims (1, 3, 5, 7, 8, 9, 10, 13, 14, and 20) having a taper, further comprising: The taper being 14/100 inch per axial inch.

22. A family of threaded pipe connections of claim (13) having a thread lead (50) and a maximum allowable angle of alignment (52) between the box and pin during assembly, further comprising: The thread lead being not less than, the thread diameter multiplied by the tangent of the specified maximum allowable angle of misalignment.

23. A screw thread form having a radial thread depth; an axial thread pitch; a crest; a stab flank; a stab flank guide surface; positioned at a guide angle with respect to the connection centerline; a pipe connection pin having pin threads; a pin thread O.D., a pin root diameter and a pin crest diameter at the pin face; a box formed with tapered threads to mate with the pin threads; a box O.D.; a box swage I.D.; radial interference existing between the mating threads; the box wall being thicker at the pin face than at the box face; the connection being in a family of pipe connections having a maximum angle of misalignment between the box and pin during assembly, further comprising: The thread depth being more than 30 percent but less than 50 percent of the axial thread pitch. The guide angle being larger than the angle of friction that acts between the mating threads, but less than 40 degrees. The pin being swaged down to the smallest OD within pipe OD tolerance and the pin ID being formed substantially equal to the average of the pipe drift diameter and the nominal pipe ID; the pin thread root diameter substantially running out at the pin OD; The box ID being swage out to substantially the pin crest diameter at face; the box thread root running out in the swaged box ID; the engaged thread length extending from the pin OD to the box ID. More radial thread interference existing between the mating threads at the pin face than at box face; Interference at the pin face being sufficient to seal rated internal fluid pressure but less than flank yield pressure; Interference at box face not being great enough to over stress the box wall when at rated pressures. All threads within that family having an optimum thread form for that range. The thread lead being not less than, the thread diameter multiplied by the tangent of the specified maximum allowable angle of misalignment.
